(19) United States
(12) Patent Application Publication
(10) Pub. No.: US 2021/0071071 A1
(43) Pub. Date: Mar. 11, 2021

(54) Multi-Model Particle Detection Using Pulse Shape Discrimination with Chemically Modified Silicone Matrices

(71) Applicant: Georgia Tech Research Corporation, Atlanta, GA (US)

(72) Inventors: Paul B. Rose, Atlanta, GA (US); Anna Erickson, Atlanta, GA (US); Alan Sellinger, Golden, CO (US)

(21) Appl. No.: 16/956,771

(22) PCT Filed: Dec. 21, 2018
(86) PCT No.: PCT/US18/67003

§ 371 Date: Jun. 22, 2020

Related U.S. Application Data
(60) Provisional application No. 62/609,816, filed on Dec. 22, 2017.

(51) Int. Cl. C09K 11/02; C09K 11/06; G01T 1/203

(52) U.S. Cl. CPC C09K 11/02; C09K 11/06; C09K 2211/1018; C09K 2211/1007; C09K 2211/1011; G01T 1/2033

(57) ABSTRACT

Chemically-modified silicone-based matrices for use in radiation detection. The base matrix is capable of multi-modal particle detection via pulse shape discrimination (PSD), relying in differences in the interaction mechanics between various types of radiation and the matrix itself to produce light with characteristic properties dependent on the incident particle type and energy. The materials, radiation detection devices using the materials, and methods of using the materials as radiation detectors.

### CROSS-REFERENCE TO RELATED APPLICATIONS

This application claims the benefit of U.S. Provisional Application No. 62/609,816 filed 22 Dec. 2017 the entire contents and substance of which is hereby incorporated by reference.

### BACKGROUND OF THE INVENTION

### 1. Field of the Invention

The present invention is generally related to materials, radiation detection devices and methods of using materials as radiation detectors, and more particularly to organic/hybrid scintillators that are capable of pulse shape discrimination (PSD) and methods of using the organic/hybrid scintillators.

### 2. Description of Related Art

Scintillator-based detectors are used in a variety of applications, including general radiation detection, monitoring, and safety including measurements, spectroscopy, and particle identification. It is useful in nuclear security, physics experiments, oil and gas well-logging, medical imaging applications, and general research in particle-based sciences.

When a scintillator material of a scintillation-based detector is exposed to ionizing radiation, the scintillator material absorbs energy of incoming radiation and scintillates, re-emitting the absorbed energy in the form of photons. A photosensor of the scintillator-based detector converts the emitted photons into an electrical signal. Radiation detection apparatuses can analyze pulses for many different reasons. Continued improvements are desired.

Organic scintillators produce light by both prompt and delayed fluorescence. The prompt decay time is typically a couple of nanoseconds, while the delayed decay time is normally on the order of hundreds of nanoseconds to tens of microseconds. Most of the light is produced by the prompt decay; however, the amount of light in the delayed component often varies as a function of the type of particle causing the excitation. The variation in the amount of light produced by delayed fluorescence can be utilized to distinguish different types of particles; this technique is known as pulse shape discrimination (PSD).

Neutron interactions in organic scintillators produce scattered protons through elastic scattering or other reactions resulting in heavier charged particles; protons and heavier charged particles have a short range and generate a high concentration of triplet states, which decay by delayed fluorescence. By contrast, gamma ray interactions in organic scintillators produce scattered electrons. Electrons have a longer range than protons and generate a lower concentration of triplet states (electrons are more likely to produce excited singlet states, which decay by prompt fluorescence). The difference in the pulse shape of the signal as a result of the ratio of prompt to delayed fluorescence produced by different types of radiation makes PSD an important method of neutron detection in an environment where gamma rays are present.

Polyvinyltoluene (PVT) is the most widely used solid detector material used for neutron/gamma detection via PSD. PVT typically uses similar scintillator dopants to liquid scintillators which has superior PSD capabilities. However, there is a gap between these materials and their properties and the needs of modern radiation detection, especially when it comes to the need for inert materials that can operate at high temperatures. Pulse shape discrimination has been performed with plastics other than PVT, but the results have been inferior to what can be achieved with liquid scintillators.

Plastic scintillators have attributes that make them more attractive than liquid scintillators for most applications. For example, liquid scintillators always present the risk of leaks, generally use flammable solvents, and need to be encapsulated in an inert environment in order to detect ionizing radiation. There have been attempts to fabricate plastics specifically for use in situations where gamma ray/neutron discrimination is required, but clear separation, using PSD, between gamma rays and neutrons is less than desirable at low energies.

Silicones have been shown to work well as an optically transparent material and is traditionally used in optical coupling materials such as grease, semi-permanent, and epoxy-like substances. One such material is polydimethylsiloxane (PDMS), which shows great characteristics for optically bonding two materials, but it has not been shown to successfully exhibit useful PSD via incorporating scintillator.

One measure of a scintillator's performance is its energy resolution (ER), a metric on the precision with which it can resolve the energy deposited in the detector by incident radiation. ER is determined from the photopeak of the pulse-height spectrum generated when a scintillator responds to irradiation. ER is determined by taking the quotient of the full-width at half-maximum (FWHM) and the centroid of the photopeak. High-performance scintillators have high ERs, corresponding to low numerical values of the quotient. Organic scintillators traditionally have poor ER, but improvements can be made with materials of superior optical quality and doping with elements heavier than typically found in organic scintillators.

Another measure of scintillator performance is its ability to distinguish between gamma radiation and neutron radiation. The Figure-of-Merit (FOM) characterizing this attribute is determined by integrating the neutron and gamma-ray output signal traces from the photodetector using multiple integration windows (fast and slow). A ratio of the integrals is plotted versus the energy, and a slice containing both the gamma-ray and neutron features is projected to produce two Gaussian-like peaks. The FOM is then calculated by dividing the separation between the peak centroids by the sum of their FWHMs.

Conventional materials have disadvantages. The crystal Cs₂LiYCl₆:Ce (CLYC) is a scintillator material having good ER and a capability to identify γ-rays and fast/thermal neutrons, but has slow decay times—microsecond scale. CYLC is also not ambient stable and will degrade fairly quickly in open air. Crystalline stilbene is an organic scintillator used for radiation detection and is well-suited for discrimination between fast neutrons and a gamma-ray background but will fog/crack/melt in warm conditions. Liquids are cost effective but can be hazardous/flammable. PVT is inexpensive for large area coverage but has aging/radiation damage issues.

Silicone-based matrices are solid and have mechanical properties configurable via processing, can be a flexible material for impact resistance, are moldable into virtually any shape, but as noted above, standard PDMS is not viable, as chemical modifications or alternate formulations are needed.

It remains a challenge to effectively use scintillators that are capable of PSD across a broad range of environments as well as particle types and energies. It is thus an intention of the present invention to provide a silicone-based, PSD capable, organic/hybrid scintillator.

### BRIEF SUMMARY OF THE INVENTION

Briefly described, in a preferred form, the present invention comprises a chemically-modified silicon base matrix that facilitates the blending and/or polymerization of scintillating dopants into the matrix itself for long term stability. This material can also optically bond to virtually any material allowing for composite scintillators and yielding superior optical transmission from one material to another.

In another exemplary form, the present invention is chemically-modified silicone-based matrices for use in radiation detection. The base matrix is capable of multi-modal particle detection via PSD, relying in differences in the interaction mechanics between various types of radiation and the matrix itself to produce light with characteristic properties dependent on the incident particle type and energy.

The present invention is a class of organic/hybrid scintillators that are capable of PSD and are more robust than current commercialized technologies. It is comprised of a silicone-based matrix together with an organic scintillator(s) that can be rapidly produced in hours instead of days. The chemically modified silicone matrix can accept traditional scintillator dopant material such as 2,5-diphenyloxazole (PPO), but also benefits from custom-designed reactive scintillator dopants.

The present invention is a rugged silicone-based scintillator capable of neutron and gamma detection through PSD that is a relatively inexpensive material moldable to many shapes with a processing time of hours instead of days. This invention can also be used to detect charged particles.

The present invention comprises a base material of a chemically modified silicone material that has a tunable phenyl (aromatic) group content that can be mixed with virtually any scintillator primary and/or secondary dopant.

The present invention exhibits significantly shorter total fabrication times over conventional materials, for example, hours vs. days. It is non-toxic and non-hazardous, as opposed to conventional PSD-capable liquids. The present invention can withstand up to approximately 225° C. without melting or losing mass, where of course plastics would melt, and liquids combust. It is less susceptible to effects from environmental factors than PVT, wherein samples can be cured in ambient atmosphere and remain water clear, while PVT requires inert conditions and can become “yellow” during processing that results in inferior detection capabilities. Certain levels of phenyl content may be required for efficient energy transfer to dopants and this can be easily tuned. Furthermore, the present inventive material can be cast into virtually any geometry desired by making use of three-dimensional (3D) printed molds.

In an exemplary embodiment, the present invention is a scintillator having pulse shape discrimination (PSD) capabilities resulting in a Figure-of-Merit (FOM) value of greater than 1.5 at a light output of less than ADDCCH 1600.

In another exemplary embodiment, the present invention is a scintillator having PSD capabilities resulting in an FOM value of greater than 1.7 at a light output of less than ADDCCH 4000.

In another exemplary embodiment, the present invention is a scintillator having PSD capabilities resulting in an FOM value of greater than 2.0.

In any exemplary embodiments, the scintillator can be a silicone-based scintillator.

In another exemplary embodiment, the present invention is a scintillator matrix with a chemical composition —[O-M-(R)(R′)]— where M is selected from the group consisting of Si, B, Ge, Ti, Sn, Pb, Bi, Sb, Zn, and W, and R and R′ are selected from the group consisting of hydrogen, vinyl, methyl, phenyl, naphthyl, and other alkyl and aromatic substituents.

In another exemplary embodiment, the present invention is a scintillator matrix with a chemical composition —[O-M-(R)(R′)]— where M is Si, R is methyl, and R′ is phenyl.

In another exemplary embodiment, the present invention is a silicone-based scintillator comprising a silicone-based scintillator matrix and dopant, wherein the total dopant concentration is less than approximately 20 mass % with respect to the matrix mass. In another exemplary embodiment the total dopant concentration is from approximately 3 to approximately 5 mass % with respect to the matrix mass.

In another exemplary embodiment, the present invention is a silicone-based scintillator comprising a silicone-based scintillator matrix and a primary dopant in a concentration of between approximately 1 to approximately 30 mass % with respect to the matrix mass.

In another exemplary embodiment, the primary dopant is selected from the group consisting of PPO, 9,9-dimethyl-2-phenyl-9H-fluorene (PhF), and alkylated soluble terphenyl derivatives. In another exemplary embodiment, the primary dopant is selected from the group consisting of reactive fluorescent dopants with functional groups that allow their chemical incorporation into the silicone matrix.

In another exemplary embodiment, the present invention is a silicone-based scintillator comprising a silicone-based scintillator matrix, a primary dopant, and a secondary dopant different than the first dopant. In another exemplary embodiment, the secondary dopant concentration is between approximately 0.1 to approximately 5 mass % with respect to the primary dopant.

In another exemplary embodiment, the secondary dopant is selected from the group consisting of 1,4-bis(5-phenyloxazol-2-yl) benzene (POPOP), and 9,9-dimethyl-2,7-di((E)-styryl)-9H-fluorene (SFS). In another exemplary embodiment, the secondary dopant is selected from the group consisting of reactive fluorescent dopants with functional groups that allow their chemical incorporation into the silicone matrix.

In another exemplary embodiment, the present invention is a silicone-based scintillator, wherein the silicone-based scintillator matrix comprises one or more isotopes to create sensitivity to thermal neutrons via nuclear reactions which produce charged particles producing distinct pulse shapes.

In another exemplary embodiment, the silicone-based scintillator matrix comprises an optically-bonded scintillator material different from the base scintillator matrix.

In another exemplary embodiment, the present invention is a silicone-based scintillator comprising a silicone-based scintillator matrix and dopant, wherein the total dopant concentration is less than approximately 20 mass % with respect to the matrix mass, and wherein the silicone-based scintillator has a processing time of less than one day.

In another exemplary embodiment, the present invention is a silicone-based scintillator comprising a base material of a chemically modified silicone material that has a tunable phenyl (aromatic) group content and dopant, wherein the total dopant concentration is less than approximately 20 mass % with respect to the base material mass.

The inventive scintillator can comprise a primary dopant concentration of between approximately 1 to approximately 30 mass % with respect to the matrix mass.

The inventive scintillator can comprise a primary dopant selected from the group consisting of PPO, 9,9-dimethyl-2-phenyl-9H-fluorene (PhF), and alkylated soluble terphenyl derivatives.

The inventive scintillator can comprise a primary dopant selected from the group consisting of reactive fluorescent dopants with functional groups that allow their chemical incorporation into the silicone matrix.

The inventive scintillator can comprise a secondary dopant concentration of between approximately 0.1 to approximately 5 mass % with respect to the primary dopant.

The inventive scintillator can comprise a second dopant selected from the group consisting of 1,4-bis(5-phenyloxazol-2-yl) benzene (POPOP), and 9,9-dimethyl-2,7-di((E)-styryl)-9H-fluorene (SFS).

The inventive scintillator can comprise a secondary dopant selected from the group consisting of reactive fluorescent dopants with functional groups that allow their chemical incorporation into the silicone matrix.

The inventive scintillator can comprise incorporating isotopes such as ¹⁰B, ⁶Li, ¹¹³Cd, ¹⁵⁷Gd, etc., to create sensitivity to thermal neutrons via nuclear reactions which produce charged particles producing distinct pulse shapes.

The inventive scintillator can comprise another optically-bonded scintillator material, either organic or inorganic, to create a composite detector.

In another exemplary embodiment, the inventive scintillator comprises a much lower total dopant concentration for efficient PSD (lower than from approximately 20 mass % with respect to the matrix mass) than the conventional PVT-based scintillators needing dopant concentrations closer to 20-30%. In other exemplary embodiments, the inventive scintillator comprises a total dopant concentration from approximately 3 to approximately 5 mass % with respect to the matrix mass.

A fast neutron detector that is appropriate for use in situations where gamma rays are present is one that can produce clearly separated neutron and gamma ray signals. The separation between the neutron and gamma ray signals can be quantified and used to determine a performance metric. FOM has been identified for fast neutron detectors and is used to establish their ability to discriminate between pulses generated by gamma rays and pulses generated by neutrons. The FOM is calculated after PSD has been performed to identify the neutron and gamma ray pulses.

The present invention according to an exemplary embodiment exhibits a FOM of approximately 2.0.

It will be understood by those of skill in the art that the present invention includes for example, a scintillator, a scintillator matrix, and a silicone-based scintillator. It will further be understood by those of skill in the art that the present invention includes the use of such materials in, for example, radiation detection. It will further be understood by those of skill in the art that the present invention includes any of the included inventive materials combined with any of the disclosed aspects or functions or specifications, even if in a list of exemplary embodiments not every combination of elements is exhaustively listed.

For example, the present invention can comprise an innovative silicone-based scintillator (A), and the present invention includes that the silicone-based scintillator has, for example, a beneficial FOM (B), or is combined with a dopant (C), or has beneficial melting properties (D), or has beneficial processing time(s) (E). And that the inventors contemplate that many combinations of these example limitations can come in any number of permutations. For example, the inventors have conceived of the idea of A+B, and A+C, and A+B+C, and A+D, and A+B+D, and so on.

Thus, as examples only, and not meaning to be bound by any specific combination of inventive features, the present invention includes many exemplary embodiments that are created by a combination of various different features.

These and other objects, features and advantages of the present invention will become more apparent upon reading the following specification in conjunction with the accompanying drawing figures.

### BRIEF DESCRIPTION OF THE DRAWINGS

FIG. 1 is a graph of optical photon emission from excited atomic electrons as they return to the ground state through various pathways as detected by a photosensor.

FIG. 2 is the PSD from the present silicone-based scintillator with 4% PPO using a PuBe source.

FIG. 3 is the PSD from an industry leading PVT material containing approximately 30% PPO using a PuBe source.

FIG. 4 illustrates the definition of FOM (reproduced from N. Zaitseva et al., “Pulse Shape Discrimination in Impure and Mixed Single-Crystal Organic Scintillators,” IEEE T.N.S. 58:6, 3411 (2011)).

FIG. 5 is an example of a market leading liquid scintillator doped with thermal neutron sensitive compounds in attempt to separate thermal and fast neutrons. Thermal neutron events appear in the middle of the fast neutron and gamma ray lobes, centered at ADCCH 800 and PSP 0.2.

FIG. 6 is an example of the present invention capable of gamma ray (lobe centered at PSP 0.1) as well as thermal (all events with PSP>0.5) and fast neutron (PSP 0.25) separation.

FIG. 7 illustrates separation FOM from FIG. 6 at a slice in the energy domain from ADCCH 1000 to 3000 (roughly 400 keVee average) showing the separation capability of thermal events (PSP>0.5) from fast neutrons and gamma rays.

FIG. 8 illustrates a silicone-based scintillator without thermal neutron dopants when exposed to a PuBe source.

FIG. 9 shows the PSD FOM as a function of energy for the experiment in FIG. 8 where the circles are the calculated FOM from the silicone-based material, the diamonds are the calculated FOM from the industry leading PVT, and the dotted line is the FOM=1.27 threshold.

FIG. 10 is a FOM vs ADC comparison of exemplary embodiments of the present invention having different representative dopant concentration and types.

FIG. 11 illustrates the light output of exemplary embodiments of FIG. 10.

### DETAIL DESCRIPTION OF THE INVENTION

To facilitate an understanding of the principles and features of the various embodiments of the invention, various illustrative embodiments are explained below. Although exemplary embodiments of the invention are explained in detail, it is to be understood that other embodiments are contemplated. Accordingly, it is not intended that the invention is limited in its scope to the details of construction and arrangement of components set forth in the following description or illustrated in the drawings. The invention is capable of other embodiments and of being practiced or carried out in various ways. Also, in describing the exemplary embodiments, specific terminology will be resorted to for the sake of clarity.

It must also be noted that, as used in the specification and the appended claims, the singular forms “a,” “an” and “the” include plural references unless the context clearly dictates otherwise. For example, reference to a component is intended also to include composition of a plurality of components. References to a composition containing “a” constituent is intended to include other constituents in addition to the one named.

Also, in describing the exemplary embodiments, terminology will be resorted to for the sake of clarity. It is intended that each term contemplates its broadest meaning as understood by those skilled in the art and includes all technical equivalents which operate in a similar manner to accomplish a similar purpose.

Ranges may be expressed herein as from “about” or “approximately” or “substantially” one particular value and/or to “about” or “approximately” or “substantially” another particular value. When such a range is expressed, other exemplary embodiments include from the one particular value and/or to the other particular value.

Similarly, as used herein, “substantially free” of something, or “substantially pure”, and like characterizations, can include both being “at least substantially free” of something, or “at least substantially pure”, and being “completely free” of something, or “completely pure”.

By “comprising” or “containing” or “including” is meant that at least the named compound, element, particle, or method step is present in the composition or article or method, but does not exclude the presence of other compounds, materials, particles, method steps, even if the other such compounds, material, particles, method steps have the same function as what is named.

It is also to be understood that the mention of one or more method steps does not preclude the presence of additional method steps or intervening method steps between those steps expressly identified. Similarly, it is also to be understood that the mention of one or more components in a composition does not preclude the presence of additional components than those expressly identified.

The materials described as making up the various elements of the invention are intended to be illustrative and not restrictive. Many suitable materials that would perform the same or a similar function as the materials described herein are intended to be embraced within the scope of the invention. Such other materials not described herein can include, but are not limited to, for example, materials that are developed after the time of the development of the invention.

Scintillation materials are used in the detection and measurement of radiation. Scintillators are composed of substances which are capable of absorbing energy given off by ionization radiation, e.g., the fission fragments emitted by radioactive elements. The absorbed energy excites fluorescent materials (fluors) contained in the scintillator, such that the fluorescent materials give off light. Such scintillators are useful in many different applications, e.g., the detection of radioactive mineral deposits, and the detection and measurement of radioactive contamination.

When radiations comprising electrically charged particles such as α-rays and β-rays penetrate a certain substance, they ionize, excite or dissociate atoms or molecules of the substance at the cost of their energy. On the other hand, the energy thus lost by the radiation and accumulated in the substance is either converted into energy in the form of thermal movement or merely emitted in the form of electromagnetic waves. Where the substance penetrated by the radiation is fluorescent or phosphorescent or contains a fluor, a fair portion of the energy produced is converted and emitted in the form of light, usually of a wavelength in the visible zone. This phenomenon of conversion of energy produced by irradiation with ionizing radiation and light emission is termed “scintillation.” In the case of radiation comprising gamma-rays and neutron rays which are devoid of electric charge, a similar phenomenon is induced by the action of secondary charged particles which are produced when the radiations interact with a substance. Generally, therefore, this phenomenon is widely utilized for the detection and measurement of ionizing radiation.

Substances capable of causing the scintillation are generally called scintillators. Examples of scintillators are inorganic crystals, e.g., sodium iodide activated by thallium, organic crystals, e.g., anthracene, stilbene, organic solutions, e.g., xylene solution of terphenyl and plastic scintillators, e.g., terphenylpolystyrene. These substances are extensively used as luminous bodies for the detection of ionizing radiation. Plastic scintillators are easy to handle and are readily moldable in desired large shapes and, owing to these merits, have come to find utility as indispensable devices in the field of research on cosmic rays and research on high-energy physics by use of particle accelerators. In recent years in the field of high-energy physics, development of large particle accelerators has increased demand for a great quantity of large plastic scintillators. Of the properties required of efficient plastic scintillators, high processibility is important in addition to those basic properties of scintillators in general, e.g., amount of emission and transparency, etc.

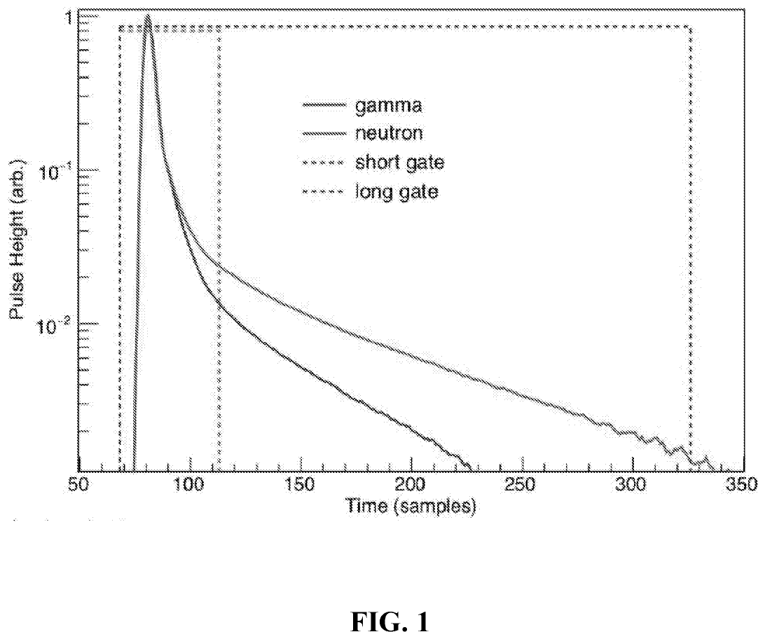

Pulse shape discrimination takes advantage of the optical photon emission from excited atomic electrons as they return to the ground state through various pathways. See FIG. 1. The mobility of singlet and triplet excited states leads to some singlets decaying producing prompt light emission and the triplet mobility can lead to triplet-triplet annihilation which leads to delayed light emission. Neutron interactions induce charged particles with more dE/dX leading to higher ionization density, which increases the chance for the delayed light emission. A ratio of the prompt vs. delayed emission determines if the event was from a neutron of gamma ray.

$$P S P = \frac{{Q}_{l o n g} - {Q}_{s h o r t}}{{Q}_{l o n g}} \qquad ( 1 )$$

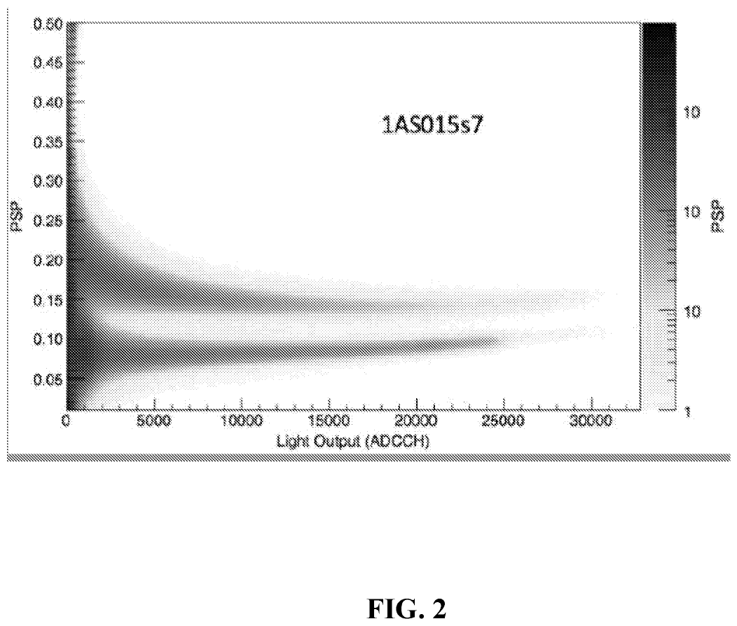

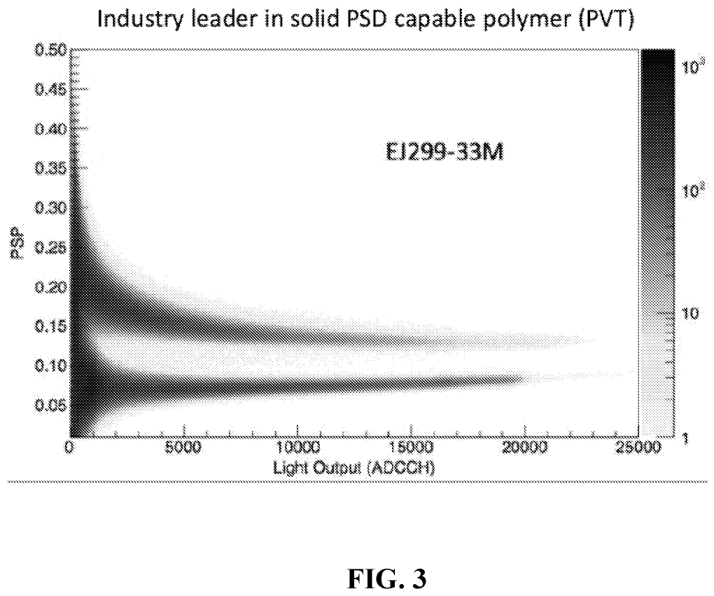

Silicone-based, PSD capable, organic scintillators have been proposed before, but this is the first actual demonstration of successful PSD comparable to that of other materials. The present invention uses a charge collection ratio Qᵣₐₜᵢₒ the tail to total pulse, Qₜₐᵢₗ/Qₜₒₜₐₗ, to define the pulse shape parameter (PSP). The Qᵣₐₜᵢₒ is the charge in the tail of the pulse to the total charge in the pulse. The present matrix shows similar PSD capability to the industry leading PVT, EJ-299, as shown in FIGS. 2-3, while using approximately seven times less PPO dopant.

The PSD techniques used to distinguish between the pulses from neutrons and the pulses from gamma rays rely on the differences in the pulse shapes produced. The pulses generated by neutrons will have a longer tail than the pulses generated by gamma rays, as the neutron pulses are the result of triplet state interactions (delayed fluorescence) and the pulses produced by gamma rays are the result of singlet state de-excitation (prompt fluorescence). Thus, the difference in the ratio of the charge in the tail of the pulse to the total charge in the pulse (the Qᵣₐₜᵢₒ) can be calculated and used to discern which type of radiation generated the pulse.

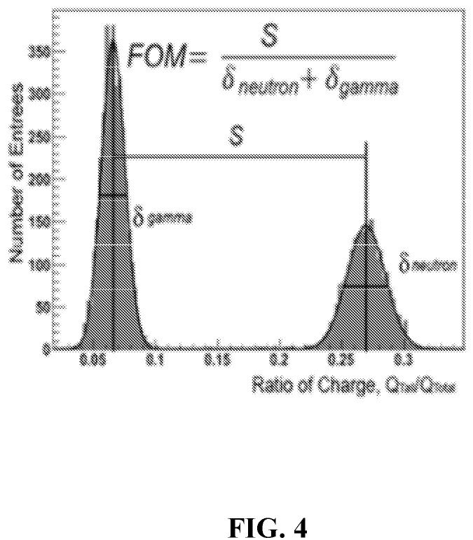

The Qᵣₐₜᵢₒ for neutron pulses should be larger than the Qᵣₐₜᵢₒ for gamma ray pulses for the same total charge deposited (FIG. 4). The FOM is calculated from the histogram of the Qᵣₐₜᵢₒ versus peak height data.

FOM can be used to determine which particular scintillator compounds and corresponding temperature ranges can be used for the dual mode application in conjunction with pulse shape discrimination.

Figure of Merit may be used to determine whether a particular scintillator compound may be useful at a particular temperature and still have sufficiently different outputs between neutrons and gamma radiation to allow for pulse shape discrimination. In the description that follows, a particular composition is provided to allow for better understanding of the concepts regarding determining whether a scintillator composition will be good for neutron-gamma pulse shape discrimination.

As used herein, FOM is defined as (note that this definition assumes that the pulse distributions are Gaussian):

$$F O M = \frac{s}{{δ}_{n e u t r o n} + {δ}_{g a m m a}} \qquad ( 2 )$$

where S≡the distance between the gamma ray and neutron peaks, and δ≡the FWHM of the peaks. See, FIG. 4.

The definition of the FOM illustrates that the larger the FOM the better the performance of the detector for gamma ray discrimination. A baseline performance requirement can be established by starting with the definition that for two peaks to be considered well separated S>3(σₙₑᵤₜᵣₒₙ+σ_{gamma}), where σ is the standard deviation. For a Gaussian distribution the FWHM=2.36 σ. Substituting these definitions into the equation (2) yields the result:

$$F O M \geq \frac{3 ( {σ}_{n e u t r o n} + {σ}_{g a m m a} )}{2.36 ( {σ}_{n e u t r o n} + {σ}_{g a m m a} )} = 1.27 \qquad ( 3 )$$

Thus, any detector with a FOM above 1.27 can be considered to have adequate PSD for fast neutron detection in the presence of gamma rays.

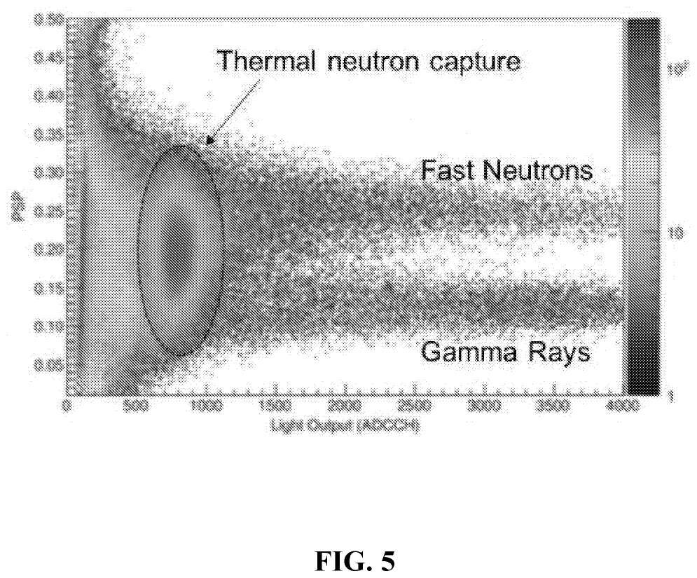

This present invention is well suited for incorporating materials beyond scintillator, for example ¹⁰B or ⁶Li, to provide thermal neutron detection abilities. These isotopes undergo nuclear reactions, which result in generation of charged particles in the material such as tritons and/or α-particles. Some commercially available liquid scintillators, for example the EJ-309B from Eljen Technologies, also incorporate these thermal neutron sensitive isotopes. Theoretically, these detectors should display a thermal neutron reaction signal that is distinguishable from the proton recoil events resulting from neutrons interacting with hydrogen. However, these thermal neutron events are usually buried in the neutron and gamma ray lobes, as seen in FIG. 5, making them useful in only thermal neutron fields.

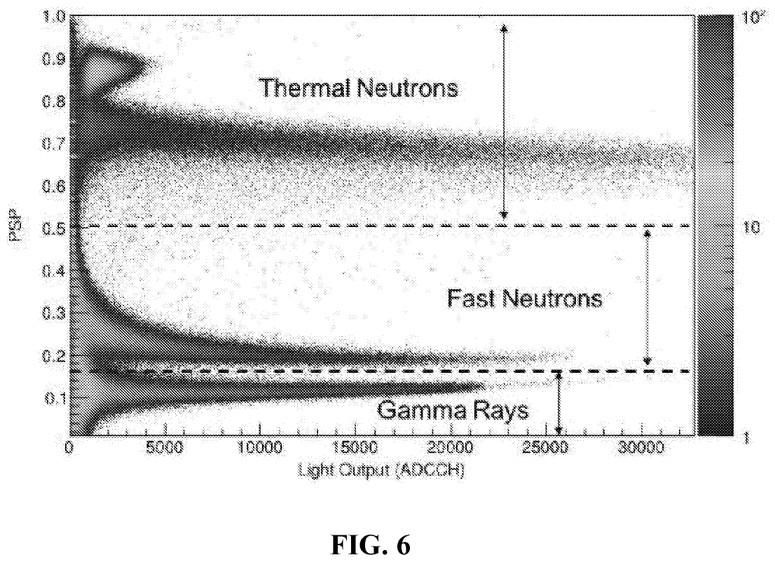

In the EJ-309B example, the thermal neutron events present in the middle of the neutron and gamma lobes in the low energy region, around ADC channel 800 in this case. In an exemplary embodiment of the present invention, enriched ⁶Li doped compound is combined into the matrix—not possible with the liquid scintillator materials. The present material easily incorporates this compound which yields thermal neutron signal through two separate neutron interactions. Both of these interactions produce a pulse shape significantly different than those of the neutron induce proton recoil events and the photon induced electron events to produce a PSD plot with four lobes as seen in FIG. 6.

As shown in FIG. 6, there is no thermalization of the neutron from the PuBe source, allowing visualization of the fast and thermal neutrons as well as the gamma ray events. All events above a PSP of 0.5 are due to thermal neutron events only. This opens the door to a viable replacement for ³He-based thermal neutron detectors.

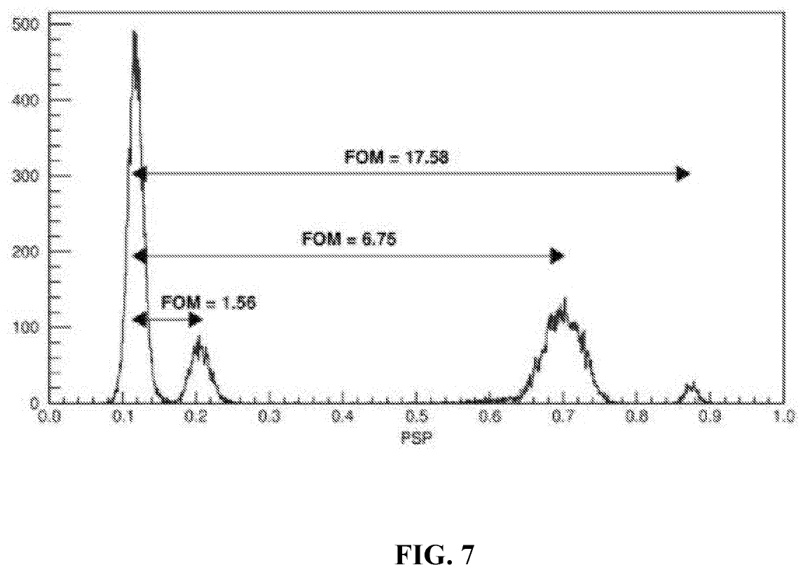

The FOM for separation of neutron and gamma events in PSD capable materials is a widely accepted standard of FOM=1.27. If a slice of events from FIG. 6 is taken in the energy axis from ADC channel 1000-3000 (average of about 400 keVee), three separation FOMs can be calculated from the gamma ray events to each of the neutron-induced lobes as seen in FIG. 7.

The thermal neutron FOMs are not part of the original intent behind the defined FOM calculation method as it was designed to determine the acceptability of a material for fast neutron detection. Considering the thermal neutron identification differences between the EJ-309B sample and the present invention, a new FOM method may be necessary to evaluate PSD-capable materials for the validity of thermal neutron separation.

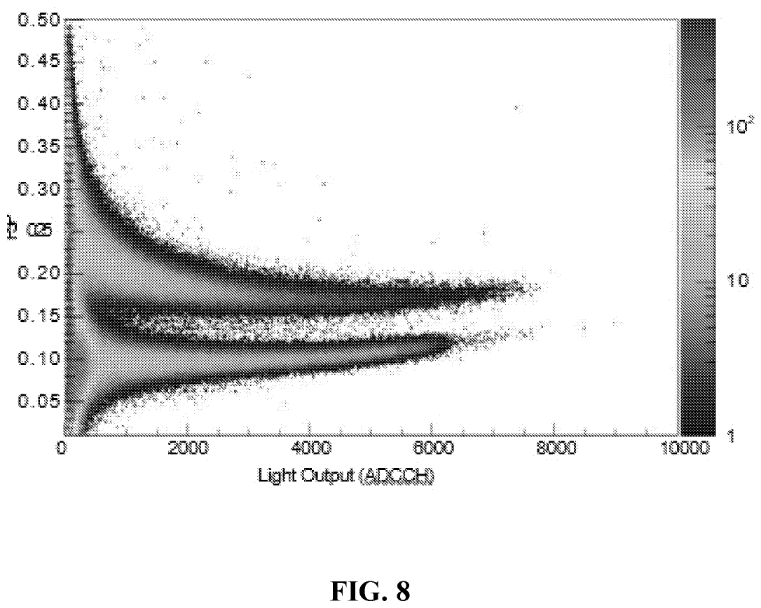

The present invention also may not include the thermal neutron sensitive compound, while still exhibiting PSD rival and sometimes even exceeding that of the industry leading PVT material. One example can be seen in FIG. 8 when the sample is exposed to a PuBe source.

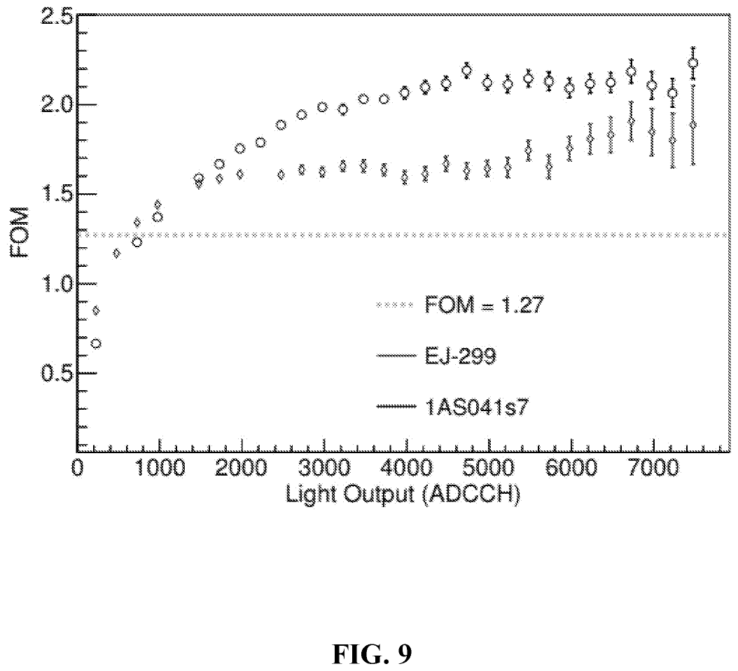

Here, a sample with custom scintillator dopants is shown. These dopants produce higher light output than PPO in some cases depending on how they are chemically modified to polymerize them into the silicone matrix. The amount of dopant used is 5 wt. % that is roughly six times lower than what is traditionally used in PVT-based scintillators. The total FOM for this exemplary sample is calculated to be 1.98 without applying a low energy cutoff. FIG. 9 illustrates the average FOM as a function of energy cutoff.

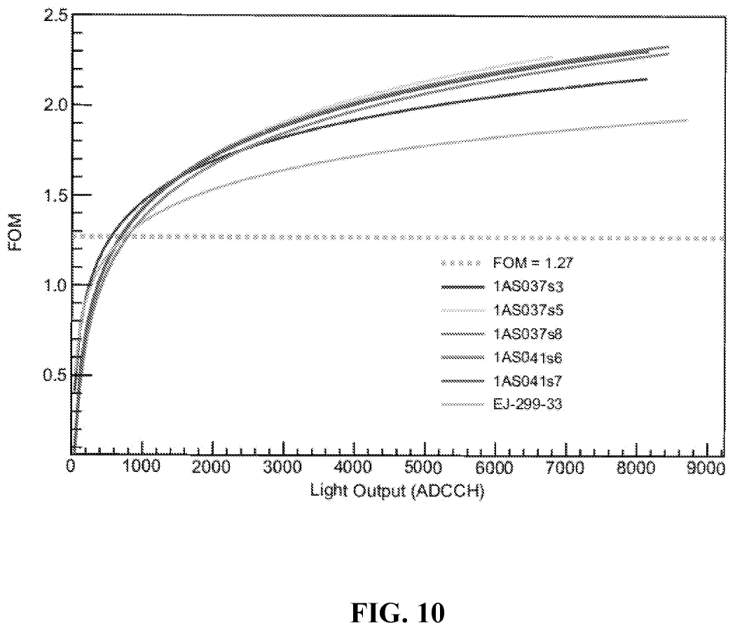

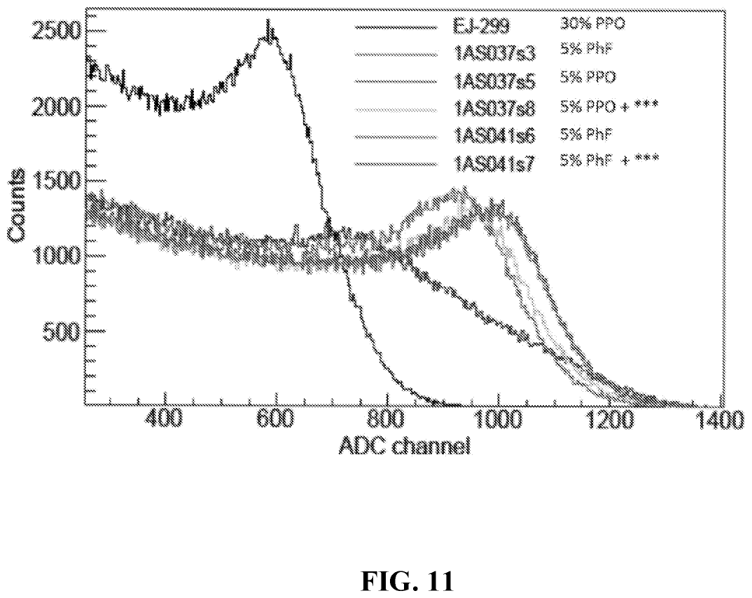

FIG. 10 is a FOM vs ADC comparison of exemplary embodiments of the present invention having different representative dopant concentration and types, and FIG. 11 illustrates the light output of exemplary embodiments of FIG. 10. In FIG. 11, *** denotes custom additives for increased incorporation of dopant into the matrix. This illustrates that the inventive material is able to retain PPO at that concentration—as evident in the difference between 1AS037s8 and 1 AS037s5

The present material exhibits PSD FOMs similar to the industry leading PVT and liquid scintillators while containing a fraction of the PPO as compared to PVT. The silicone matrix does not suffer from many of the common problems of other organic scintillators; the material is completely inert to most environmental conditions such as temperature and impact.

Liquid scintillators are generally toxic and flammable limiting the potential applications, especially in mission critical areas or where the detector may be subjected to impacts. The present silicone matrix is completely inert and nonhazardous. It is also incredibly robust to impacts as it can be cured to be slightly elastic.

The present material also does not suffer from hazing or yellowing like PVT plastics do. The present cured silicone detectors can withstand temperatures up to 225° C. without melting or losing mass. As is known by those of skill in the art, these temperatures would cause most liquid scintillators to combust, all plastic scintillators to melt, and dopants to be leached out and/or aggregate to cause failure.

Experiments were carried out using a CAEN DT5730 14-bit digitizer operating at 500 MS/s. The DPP-PSD firmware was used with CAEN CoMPASS software. This well-known and validated software, firmware, and hardware combination was chosen for its excellent PSD capability and because it is available to the general public making the experiments highly reproducible by other researchers. Some groups have reported significantly higher FOMs for the PVT material used in our control sample, but those experiments are not reproducible without their custom experimental setup.

The radiation sources used were a 1-Ci PuBe source for PSD measurements and a 273-μCi ¹³⁷Cs source for light output and spectroscopic comparisons. No collimation or neutron/gamma attenuators were used, also done for reproducibility. A structural holder was assembled from a chemistry lab stand and multiple clamps. The dimensions of the setup were held constant through all experiments. There was a dedicated holder for each source and the source to detector distance was fixed when the EJ-299 control sample detected 2000 count per second.

The silicone and PVT samples were all 1.9 cm in diameter and 1.9 cm long weighing 6 g each. These were wrapped in PTFE taps as a reflector and connected to the Hamamatsu R6095 pocket multichannel analyzer (PMT) using Bicron BC-480 optical grease. A 3D printed dome of was designed with 1-mm walls and fabricated to act as a light-proof vessel for the sample. The inside and outside of the PLA printed vessel was spray painted black to ensure no light entered the sample/PMT junction.

Numerous characteristics and advantages have been set forth in the foregoing description, together with details of structure and function. While the invention has been disclosed in several forms, it will be apparent to those skilled in the art that many modifications, additions, and deletions, especially in matters of shape, size, and arrangement of parts, can be made therein without departing from the spirit and scope of the invention and its equivalents as set forth in the following claims. Therefore, other modifications or embodiments as may be suggested by the teachings herein are particularly reserved as they fall within the breadth and scope of the claims here appended.

What is claimed is:

1. A scintillator having pulse shape discrimination (PSD) capabilities resulting in a Figure-of-Merit (FOM) value of greater than 1.5 at a light output of less than ADDCCH 1600.

2. A scintillator having PSD capabilities resulting in a FOM value of greater than 1.7 at a light output of less than ADDCCH 4000.

3. A scintillator having PSD capabilities resulting in a FOM value of greater than 2.0.

4. A silicone-based scintillator having PSD capabilities resulting in a FOM value of greater than 1.5 at a light output of less than ADDCCH 1600.

5. A silicone-based scintillator having PSD capabilities resulting in a FOM value of greater than 1.7 at a light output of less than ADDCCH 4000.

6. A silicone-based scintillator having PSD capabilities resulting in a FOM value of greater than 2.0.

7. A silicone-based scintillator matrix with a chemical composition:
—[O-M-(R)(R′)]—
wherein M is selected from the group consisting of Si, B, Ge, Ti, Sn, Pb, Bi, Sb, Zn, and W; and
wherein R and R′ are each selected from the group consisting of hydrogen, vinyl, methyl, phenyl, naphthyl, and other alkyl and aromatic substituents.

8. A silicone-based scintillator comprising:
silicone-based scintillator matrix of claim 7; and
dopant;
wherein the total dopant concentration is less than approximately 20 mass % with respect to the matrix mass.

9. The silicone-based scintillator of claim 8, configured to have PSD capabilities resulting in a FOM value of greater than 1.5 at a light output of less than ADDCCH 1600.

10. The silicone-based scintillator of claim 8, configured to have PSD capabilities resulting in a FOM value of greater than 1.7 at a light output of less than ADDCCH 4000.

11. The silicone-based scintillator of claim 8, configured to have PSD capabilities resulting in a FOM value of greater than 2.0.

12. The silicone-based scintillator of claim 8, wherein the total dopant concentration is from approximately 3 to approximately 5 mass % with respect to the matrix mass.

13. A silicone-based scintillator comprising:
silicone-based scintillator matrix of claim 7; and
a primary dopant in a concentration of between approximately 1 to approximately 30 mass % with respect to the matrix mass.

14. The silicone-based scintillator of claim 13, wherein the primary dopant is selected from the group consisting of PPO, 9,9-dimethyl-2-phenyl-9H-fluorene (PhF), and alkylated soluble terphenyl derivatives.

15. The silicone-based scintillator of claim 13, wherein the primary dopant is selected from the group consisting of reactive fluorescent dopants with functional groups that allow their chemical incorporation into the silicone matrix.

16. The silicone-based scintillator of claim 13 further comprising a secondary dopant different than the first dopant.

17. The silicone-based scintillator of claim 16, wherein the secondary dopant concentration is between approximately 0.1 to approximately 5 mass % with respect to the primary dopant.

18. The silicone-based scintillator of claim 16, wherein the secondary dopant is selected from the group consisting of 1,4-bis(5-phenyloxazol-2-yl) benzene (POPOP), and 9,9-dimethyl-2,7-di((E)-styryl)-9H-fluorene (SFS).

19. The silicone-based scintillator of claim 16, wherein the secondary dopant is selected from the group consisting of reactive fluorescent dopants with functional groups that allow their chemical incorporation into the silicone matrix.

20. The silicone-based scintillator of claim 13, wherein the silicone-based scintillator matrix comprises one or more isotopes to create sensitivity to thermal neutrons via nuclear reactions which produce charged particles producing distinct pulse shapes.

21. The silicone-based scintillator of claim 13, wherein the silicone-based scintillator matrix comprises an optically-bonded scintillator material different from the base scintillator matrix.

22. A silicone-based scintillator comprising:
silicone-based scintillator matrix; and
dopant;
wherein the total dopant concentration is less than approximately 20 mass % with respect to the matrix mass; and
wherein the silicone-based scintillator has a processing time of less than one day.

23. A silicone-based scintillator comprising:
a base material of a chemically modified silicone material that has a tunable phenyl (aromatic) group content; and
dopant;
wherein the total dopant concentration is less than approximately 20 mass % with respect to the base material mass.

24. A silicone-based scintillator matrix with a chemical composition:
—[O-M-(R)(R′)]—
wherein M is Si;
wherein R is methyl; and
wherein R′ is phenyl.

25. A silicone-based scintillator comprising:
silicone-based scintillator matrix of claim 24; and
dopant;
wherein the total dopant concentration is less than approximately 20 mass % with respect to the matrix mass.

26. The silicone-based scintillator of claim 25, configured to have an FOM of greater than 1.5 at a light output of less than ADDCCH 1600.

27. The silicone-based scintillator of claim 25, configured to have an FOM of greater than 1.7 at a light output of less than ADDCCH 4000.

28. The silicone-based scintillator of claim 25, configured to have an FOM of greater than 2.0.

29. The silicone-based scintillator of claim 25, wherein the total dopant concentration is from approximately 3 to approximately 5 mass % with respect to the matrix mass.

30. A silicone-based scintillator comprising:
silicone-based scintillator matrix of claim 24; and
a primary dopant in a concentration of between approximately 1 to approximately 30 mass % with respect to the matrix mass.

31. The silicone-based scintillator of claim 30, wherein the primary dopant is selected from the group consisting of PPO, 9,9-dimethyl-2-phenyl-9H-fluorene (PhF), and alkylated soluble terphenyl derivatives.

32. The silicone-based scintillator of claim 30, wherein the primary dopant is selected from the group consisting of reactive fluorescent dopants with functional groups that allow their chemical incorporation into the silicone matrix.

33. The silicone-based scintillator of claim 30 further comprising a secondary dopant different than the first dopant.

34. The silicone-based scintillator of claim 33, wherein the secondary dopant concentration is between approximately 0.1 to approximately 5 mass % with respect to the primary dopant.

35. The silicone-based scintillator of claim 33, wherein the secondary dopant is selected from the group consisting of 1,4-bis(5-phenyloxazol-2-yl) benzene (POPOP), and 9,9-dimethyl-2,7-di((E)-styryl)-9H-fluorene (SFS).

36. The silicone-based scintillator of claim 33, wherein the secondary dopant is selected from the group consisting of reactive fluorescent dopants with functional groups that allow their chemical incorporation into the silicone matrix.

37. The silicone-based scintillator of claim 30, wherein the silicone-based scintillator matrix comprises one or more isotopes to create sensitivity to thermal neutrons via nuclear reactions which produce charged particles producing distinct pulse shapes.

38. The silicone-based scintillator of claim 30, wherein the silicone-based scintillator matrix comprises an optically-bonded scintillator material different from the base scintillator matrix.
